(19) United States
(12) Patent Application Publication
(10) Pub. No.: US 2015/0379247 A1
(43) Pub. Date: Dec. 31, 2015

(54) SYSTEM AND METHOD FOR DYNAMICALLY GENERATED CHALLENGE-RESPONSE PASSWORDS

(71) Applicant: Disney Enterprises, Inc., Burbank, CA (US)

(72) Inventors: Steven Makofsky, Sammamish, WA (US); Nitzan Katz, Los Altos, CA (US)

(73) Assignee: Disney Enterprises, Inc.

(21) Appl. No.: 14/320,577

(22) Filed: Jun. 30, 2014

(51) Int. Cl. G06F 21/31; H04L 29/06; G06F 21/36

(52) U.S. Cl. CPC G06F 21/31; G06F 21/36; H04L 63/08; H04L 63/10

(57) ABSTRACT

A device and method for challenge-response authentication are described herein. A challenge may be presented to a user on a computing device that includes visual information. Users may input a valid response by selecting and/or entering at least part of visual information. Elements of the visual information may be associated with text. A text-based key may be compiled based on the user entry and/or selection. The text-based key may be provided to an authenticator to authenticate the user to a protected resource.

### FIELD OF THE DISCLOSURE

This disclosure relates to challenge-response authentication.

### BACKGROUND

Some known implementations of challenge-response authentication require users to input complex text-based keys which have been set as a “password” for authentication to access a protected resource. For example the challenge may be asking the user for the password and the valid response may be the correct password. Password generation may have restrictions, for example, may require a complex phrase, least one number, at least one letter, at least one punctuation mark, contain no identifiable user information (e.g., a birthday, first name, etc.) and/or other considerations of password restrictions. In response to an authentication challenge requiring input of such as a password, the user must of course remember the password.

### SUMMARY

One or more aspects of the disclosure relates to a computing device for challenge-response authentication of a user to a protected resource. In accordance with one or more embodiments described herein, an authentication challenge may be presented to a user on the computing device. The authentication challenge may include visual information (e.g., non-textual information). In some embodiments, the visual information may include elements depicting one or more of a color, image, geometric shape, and/or other considerations of non-textual information. The elements may be associated with portions of text (e.g., a word, letter, number, sentence, punctuation, glyph, phrase, symbol, etc.). Users may “input” a text-based key used for authentication to the protected resource by entering and/or selecting one or more portions of the visual information (e.g., one or more of the non-textual elements). The entry and/or selection may be translated into a text-based key based on the known text associations. A valid response to the challenge may be an entry and/or selection that is in accordance with a valid sequence of entry and/or selection (e.g., as set by the user when initiation an account with the protected resource) that translates to the valid text-based key. Thus, users may not be required to remember the complex text-based key since the text-based key may be generated automatically based on the entered and/or selected sequence of elements of the presented visual information.

In some embodiments, the computing device may include one or more physical processors configured by computer-readable instruction to execute one or more computer program components. The computer program components may include one or more of a challenge component, a response component, a translation component, an authentication component, and/or other components.

The challenge component may be configured to present an authentication challenge to the user of the computing device in order to authenticate the user to a protected resource that is accessible through the computing device. Presenting the authentication challenge may include presenting visual information.

The response component may be configured to receive non-textual information entered and/or selected by the user as a response to the authentication challenge. Receiving the non-textual information may comprise receiving user entry and/or selection of at least a portion of the presented visual information.

The translation component may be configured to translate the received non-textual information to a text-based key used for authentication. Translating the received non-textual information to a text-based key may comprise compiling the text-based key based on the user entry and/or selection of portions of the visual information.

The authentication component may be configured to provide the translated text-based key to an authenticator to authenticate the user. In response to the authenticator authenticating the user based on the translated text-based key, the user may be provided access to the protected resource.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system for challenge-response authentication.

FIG. 2 illustrates an implementation of a computing device used in the system of FIG. 1.

FIG. 3 illustrates an implementation of a user interface configured to receive user input in response to a presented authentication challenge.

FIG. 4 illustrates a database of associations between visual information presented in an authentication challenge and text elements used to generate a text-based key for authentication.

FIG. 5 illustrates another implementation of a user interface configured to receive user entry and/or selection in response to a presented authentication challenge.

FIG. 6 illustrates another implementation of a user interface configured to receive user entry and/or selection in response to a presented authentication challenge.

FIG. 7 illustrates a method of challenge-response authentication.

### DETAILED DESCRIPTION

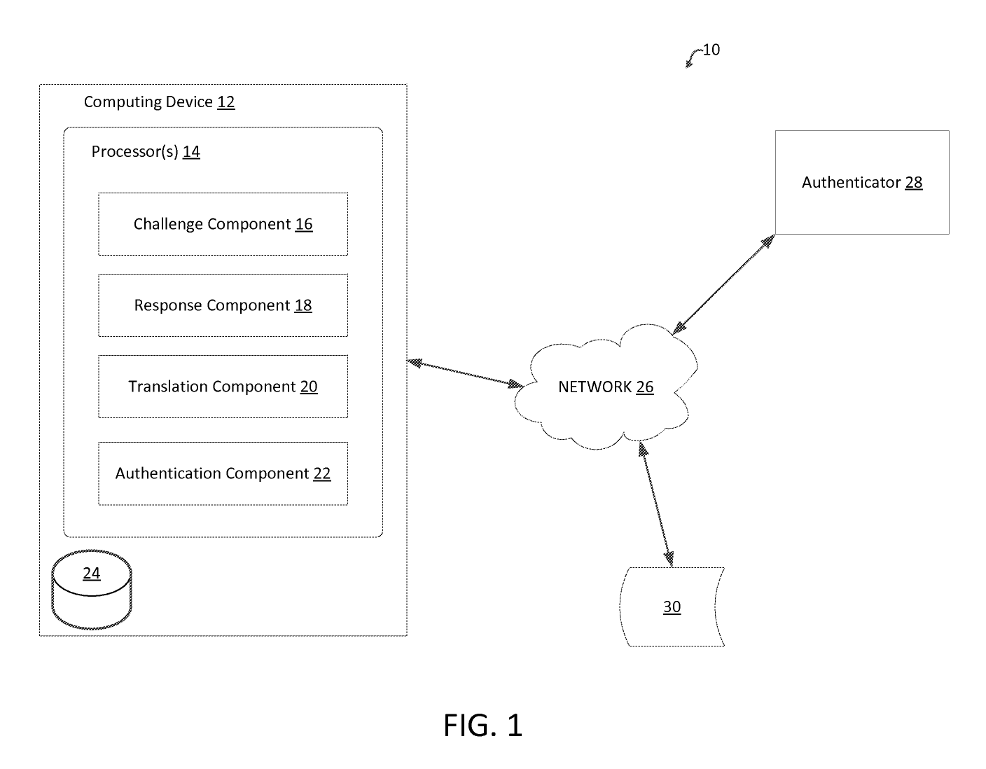

FIG. 1 illustrates a system 10 for challenge-response authentication of a user to a protected resource. The user may employ a computing device 12 configured to present an authentication challenge on a display and/or interface of the computing device 12. The computing device 12 may be configured to receive user entry and/or selection of non-textual information as a response to the authentication challenge. The computing device 12 can include, for example, a client device, a cellular telephone, a smartphone, a laptop, a tablet computer, a desktop computer, a television set-top box, smart TV, a gaming console, and/or other device suitable for the intended purposes as described herein and/or other considerations. User entry and/or selection of information may be facilitated by one or more input components of the computing device 12, for example, a keyboard, a mouse, a touchscreen, voice-recognition, gesture recognition, and/or other suitable component configured to accept user entry and/or selection of information in response to the presented authentication challenge.

Known techniques for challenge-response authentication may be undesirable for young children and adolescents due to the complexity and difficulty to remember passwords for authentication. As such, one or more implementations of the system 10 described herein may be particularly advantageous to provide challenge-response authentication suitable for children wishing to access a protected resource, such as, without limitation, a virtual space and/or an online game taking place within a virtual space. Briefly, the generation of a text-based key for authentication may be provided through user input comprising user entry and/or selection of non-textual information, such as a series of images and/or colors.

In some implementations, presenting the authentication challenge may comprise presenting visual information, such that receiving user entry and/or selection of non-textual information as a response to the authentication challenge may comprise user entry and/or selection of at least a portion of the presented visual information. In some implementations, the visual information may include one or more non-textual interface elements that depict one or more of an image, color, and/or other non-textual information. The interface elements may be associated with a portion of text (e.g., a word, letter, number, sentence, punctuation, glyph, phrase, symbol, etc.). In some implementations, the interface elements may be individually associated with a portion of text. In some implementations, sequences of interface elements may be associated with a portion of text.

User entry and/or selection of one or more of the presented interface elements may be translated into a text-based key (e.g., a password). The translation may be based on the selections and a compilation of the text (e.g., a text string) associated with the interface elements in accordance with the selections. The compiled text string may define the text-based key to be used for authentication for access to a protected resource. In some implementations, the text associations may be known to the user. In some implementations, the text associations may be unknown to the user. The text associations may be stored in an electronic database that is stored by one or more of the computing device 12, an authenticator 28, and/or an external resource 30.

In some implementations, receiving user entry and/or selection of non-textual information as a response to the authentication challenge may comprise user input of audio information that describes at least a portion of the presented visual information. For example, user may verbalize their response (as opposed to entry and/or selection). In some implementations, the computing device may include in audio recording and/or capturing device (e.g., a microphone input). As an illustrative example, an authentication challenge may present one or more non-textual interface elements that depict one or more of an image, color, and/or other non-textual information. The user may “select” one or more of the interface elements as the response through audio input (e.g., to “select” an element depicting the color “blue”, the user may say the word “blue”). User input of audio information may be translated into a text-based key in the same or similar manner as described herein.

In FIG. 1, providing the challenge-response authentication may include presenting the challenge-response authentication on the computing device 12 and providing an authentication text-based key to an authenticator 28 over a network 32, such as the Internet. The computing device 12 may include one or more processors configured to execute one or more computer components for implementing a challenge-response authentication and to facilitate communication with an authenticator 28 to provide access to a protected resource. In some implementations, however, the authenticator 28 may be an entity that is local to the computing device 12 insofar that communication of the computing device 12 with the authenticator 28 is performed locally (e.g., not over a network). The computing device 12 may include processor(s) 14.

The computer program components may include one or more of a challenge component 16, a response component 18, a translation component 20, an authentication component 22, and/or other components. The computing device 12 may be configured to communicate with one or more external resources 30 and/or authenticator 28, according to /server, /, and/or other communications architecture.

The challenge component 16 may be configured to present an authentication challenge to the user of the computing device 12 in order to authenticate the user to a protected resource accessible through the computing device 12. Presentation may be facilitated by a display and/or interface component of the computing device 12 (e.g., a screen, monitor, touchscreen, etc.). A protected resource may include, without limitation, one or more of a bank account, a virtual space, an online game taking place in a virtual space, and/or other protected resource requiring user authentication for access.

In some implementations, presenting the authentication challenge may include presenting visual information, wherein the visual information comprises at least part of the authentication challenge. The challenge may be associated with a valid response facilitating authentication. The valid response may comprise entry and/or selection of one or more portions of the visual information in a valid order, sequence, timing, frequency, and/or other considerations of a valid response. In some implementations described in more detail herein, the user entry and/or selection of visual information may be translated to a text-based key that may be used for conventional text-based password authentication. In some implementations, the valid response may have been pre-selected and/or entered by the user when setting up an account with the protected resource to be used for subsequent authentication sessions.

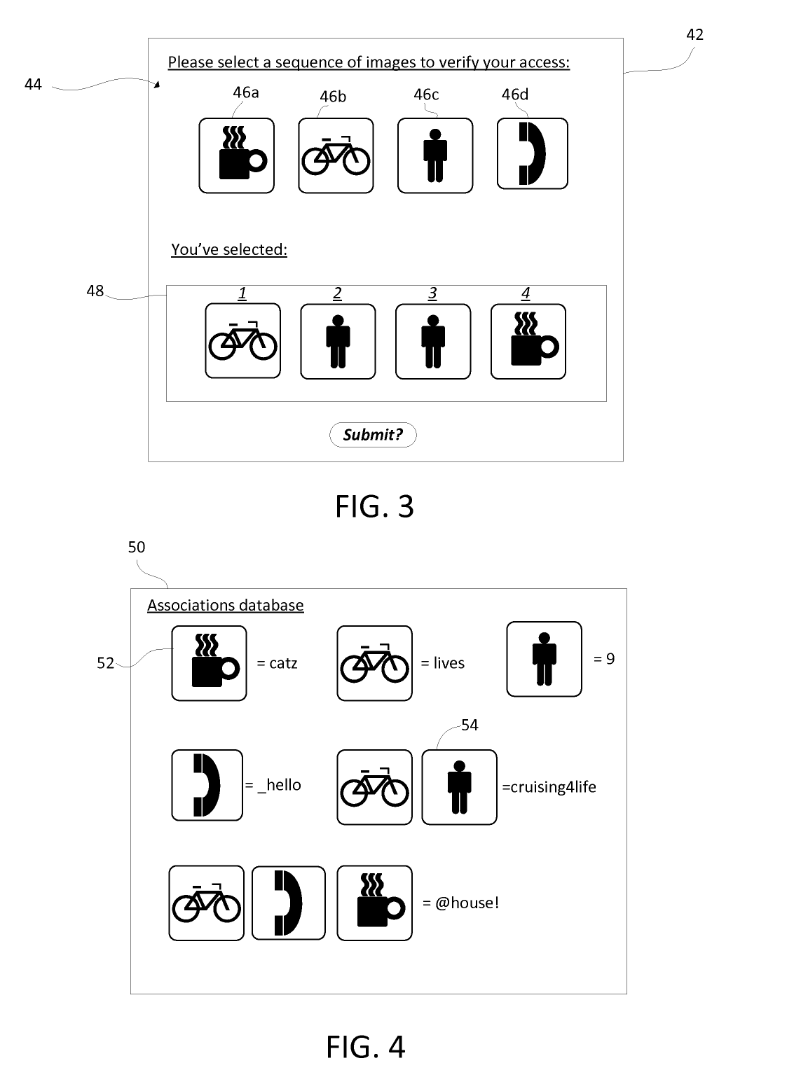

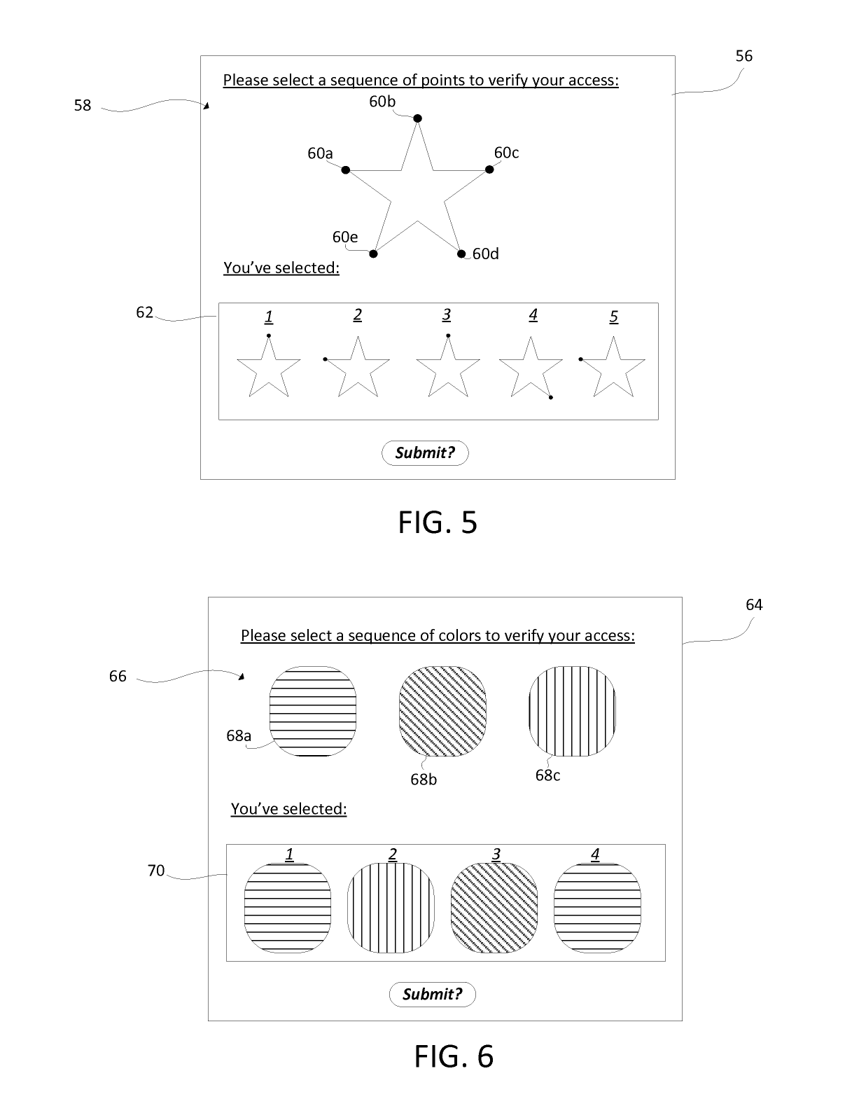

In some implementations, the visual information of an authentication challenge may comprise one or more non-textual interface elements. In some implementations, one or more interface elements may comprise an array of interface elements. In some implementations, individual interface elements may depict one or both of a color and/or image. In some implementations, one or more interface elements may be associated with parts of a geometric shape (e.g., a point on a star). Examples of authentication challenges and user responses are shown in FIG. 3, FIG. 5, and FIG. 6, and are described in more detail herein.

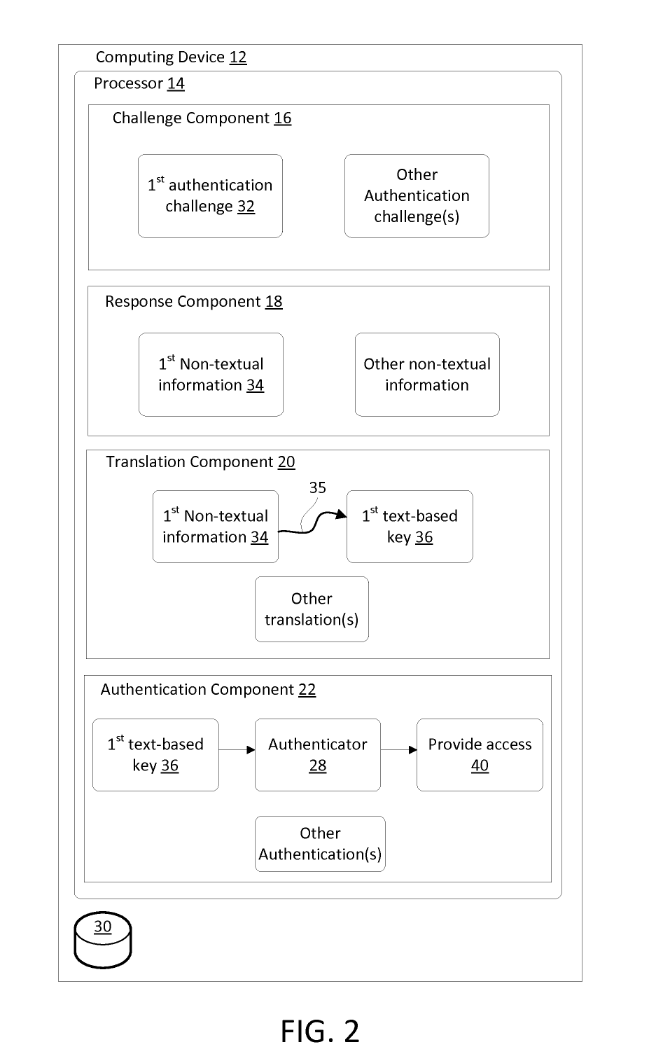

As an illustrative example in FIG. 2, the challenge component 16 may be configured to present a first authentication challenge 32 on the computing device 12 (e.g., on a display and/or user interface of the computing device 12). The presentation of the first authentication challenge 32 may include presenting visual information representing the first authentication challenge 32.

Returning to FIG. 1, the response component 18 may be configured to receive non-textual information entered and/or selected by the user as a response to the authentication challenge. In some implementations, receiving non-textual information may comprise receiving user entry and/or selection of at least a portion of the presented visual information representing the authentication challenge. For example, in implementations where the presented visual information comprises one or more interface elements, receiving non-textual information may comprise receiving user entry and/or selection of one or more of the interface elements.

As an illustrative example in FIG. 2, the response component 18 may be configured to receive first non-textual information 34 entered and/or selected by the user of the computing device 12 in response to the first authentication challenge 32.

Returning to FIG. 1, the translation component 20 may be configured to translate the received non-textual information to a text-based key. Translating the received non-textual information to a text-based key may comprise compiling the text-based key based on the user entry and/or selection of one or more of the interface elements and/or other visual information. In some implementations, portions of the visual information (e.g., the interface elements) may be associated with one or more portions of text (e.g., a letter, glyph, word, phrase, mark, punctuation, symbol, etc.).

Associations may be stored and/or otherwise managed by a database (e.g., database 50 in FIG. 4), such that compiling the text-based key based on the user entry and/or selection of one or more of the interface elements comprises accessing the database and compiling the associated portions of text thereof, described in more detail herein. Once the text-based key is compiled, it may be used (e.g., by an authenticator) to authenticate a user via text-based password authentication. In some implementations, the compiling of the text-based key may be unknown to the users. In some implementations, the compiling of the text-based key may be known to the users.

In some implementations, interface elements of an authentication challenge may be individually associated with text. Compiling the text-based key may comprise determining portions of the text-based key from text associated with the individual selections of the interface elements, and generating the text-based key based on the text. In some implementations, the associations of interface elements to text may be arbitrary and/or otherwise random associations. For example, an interface element depicting a tree may be associated with any arbitrary text and/or text string, for example, “&eat_pix”. Therefore, user selection of an interface element depicting a tree that is associated with the text “&eat_pix” may result in at least a portion of a translated text-based key comprising the term “$eat_pix”. The text-based key may comprise more or less text elements depending on or more other interface elements entered and/or selected by the user in response to an authentication challenge. For example, another interface element of the authentication challenge may depict the color blue that may be associated with an arbitrary text string such as “pa$$word”. The authentication challenge may include other interface elements. In response to the authentication challenge, the user may enter and/or select the interface element depicting the tree, followed by the interface element depicting the color blue. This selection may then be translated to a text-based key by compiling the associated texts, e.g., in this example, to recite “$eat_pixpa$$word”. Thus, the user is able to generate a complex password, without the need to memorize complex phrases. More examples are provided herein with reference to FIG. 3-FIG. 6.

In some implementations, sequences of two or more interface elements entered and/or selected by a user in response to an authentication challenge may be associated with text. In other words, a sequence of two or more interface element selections may be associated with text that is different than the individual associations of the elements with text. As a continued illustrative example following the above example of the “tree” and “blue” interface elements, user entry and/or selection of “blue” interface element followed by an entry and/or selection of “tree” interface element may be associated with text that is different than the compilation of the individually associated texts. For example, instead of this sequence of selections resulting in text string “pa$$word$eat_pix”, the sequence may be associated with a different arbitrary text string, for example, “2infinity&beyond!” based on the sequence of the selections. More examples are provided herein with reference to FIG. 3-FIG. 6.

As an illustrative example in FIG. 2, the translation component 20 may be configured to translate 35 the first non-textual information 34 to a first text-based key 36. The translation may be made in accordance with one or more implementations described herein.

Returning to FIG. 1, the authentication component 24 may be configured to provide the translated text-based key to authenticator 28 to authenticate the user. In response to the authenticator 28 authenticating the user based on the translated text-based key, access to the protected resource may be provided to the user. In response to the authenticator 28 not authenticating the user based on the translated text-based key (e.g., due to invalid response to the authentication challenge), access may not be granted to the user. The user may be prompted to retry a response.

In some implementations, the authenticator 28 may be configured to access and/or manage one or more user profiles and/or user information associated a protected resource. In some implementations, the authenticator 28 may be local to the protected resource (e.g., operating on a remote server), or may be a standalone server operating remotely. In some implementations, the authenticator 28 may be local to the computing device 12. The one or more user profiles and/or user information may include information stored by authenticator 28, one or more of computing devices 12, and/or other storage locations. The user profiles may include, for example, information identifying users (e.g., a username or handle, a number, an identifier, and/or other identifying information) within the virtual space, security login information (e.g., a login code, a valid text-based key used in challenge-response authentication), resource account information, subscription information, virtual (or real) currency account information (e.g., related to currency held in credit for a user), relationship information (e.g., information related to relationships between users in the protected resource), resource usage information (e.g., a log-in history indicating the frequency and/or amount of times the user logs-in to the user accounts, information related to the current log-in state of the user, and/or other information), demographic information associated with users, interaction history among users in the protected resource, information stated by users, browsing history of users, a computing device identification associated with a user, a phone number associated with a user, and/or other information related to users and a protected resource.

The above examples of translating received non-textual information to a text-based key based on text associations of the interface element, individually and/or in sequence, are provided for illustrative purposes only and are not intended to be limiting. As such, additional example provided with reference made to FIG. 3-FIG. 6 are also not intended to be limiting but instead may be provided to portray the overall scope and intent of the present disclosure as may become apparent.

FIG. 3 illustrates an implementation of a user interface 42 of a computing device depicting an authentication challenge 44. The authentication challenge 44 may include visual information, such as one or more non-textual interface elements, 46a-d, each depicting an image. The user interface may include a user response bar 48 configured to receive user entry and/or selection of one or more of the interface elements 46a-d as response to the authentication challenge 44. In some implementations, entry and/or selection may be facilitated by users selecting (e.g., clicking) one or more of the interface elements 46a-d, wherein the user selection appears on the response bar 48. In some implementations, entry and/or selection may be facilitated by “drag-and-drop” selection, and/or other considerations of user entry and/or selection. In some embodiments, the user response bar 48 may display the user selections in the order (e.g., sequence) that it was selected.

It is noted that although the current implementation of the user interface 42 currently depicts four interface elements 46a-d, in other implementations more or less interface elements may be provided. Further, although it there is currently depicted four user selections in the user response bar 48, in other implementations, user entry and/or selections of the visual information in response to an authentication may include more or less selections that shown. In some implementations, user entry and/or selection may or may not allow repeated selection of the same interface element.

As described herein, the user entry and/or selection of non-textual information (e.g., one or more of the interface elements 46a-d) may be translated to a text-based key used for authentication to a protected resource. In some implementations, translation may be facilitated by an association database that maintains associations of interface element selections and portions of text. FIG. 4 depicts an exemplary implementation of an association database 50 configured to maintain associations between individual and sequenced selections of interface elements and portions of text. For example, an individual interface element, such as the element depicting a coffee mug 52 (e.g., element 46a in FIG. 3), may be associated with an arbitrary string of text, such as “catz”. Other associations for individual elements are shown for illustrative purposes.

In some implementation, sequences of interface elements may be associated with an arbitrary text string, which may be different than the individual associations thereof. For example, a sequence 54 of the interface element depicting a bicycle (e.g., element 46b in FIG. 3) and the interface element depicting the man (e.g., element 46c in FIG. 3) may be associated with an arbitrary text string, such as “cruising4life”. This text string may be different than a compilation of the individual text associations, since individually the element depicting the man may be associated with the text string “9” while the element depicting the bicycle may be association with the text string “lives”. By employing the associations listed in association database 50, and now referring back to FIG. 3, the user entry and or selection illustrated in the user response bar 48 may translate to a text-based key reciting “cruising4life9catz”.

FIG. 5 illustrates another implementation of an authentication challenge 58 presented on a user interface 56. In this implementation, the authentication challenge 58 may present visual information, such as interface elements 60a-e, each representing a point on a geometric shape (e.g., a 5 pointed star). Receiving user entry and/or selection of the visual information may comprise user entry and/or selection of one or more of the interface elements 60a-e representing the points on the star. User entry and/or selection may be display in the user response bar 62. The entry and/or selection may be translated into a text-based key using an association database for the individual and/or sequenced selections, similar to the association database 50 shown in FIG. 4.

FIG. 6 illustrates another implementation of an authentication challenge 66 presented on a user interface 64 of a computing device. In this implementation, the authentication challenge 66 may present visual information, such as interface elements 68a-c, each depicting a different color. Receiving user entry and/or selection of the visual information may comprise user entry and/or selection of one or more of the interface elements 68a-c. User entry and/or selection may be displayed in the user response bar 70. The entry and/or selection may be translated into a text-based key using an association database for the individual and/or sequenced selections, similar to the association database 50 shown in FIG. 4.

It is noted that although the authentication challenges shown in FIG. 3, FIG. 5, and FIG. 6 depict images, geometric shape, and colors individually, in some implementations, authentication challenge may be configured to present a combination of such visual information and/or other information suitable for the intended purposes described herein. For example, in other implementations, visual information may instead be audio information (e.g., interface elements that when selected play an audio track), wherein multiple audio tracks are played and the user must select the audio tracks in the correct order, similar to user entry and/or selection of interface elements as described herein in order to provide a valid response.

Returning to FIG. 1, the computing device 12, authenticator 28 and/or external resources 30 may be operatively linked via one or more electronic communication links. For example, such electronic communication links may be established, at least in part, via a network such as the Internet, a local area network, and/or other networks. It will be appreciated that this is not intended to be limiting, and that the scope of this disclosure includes implementations in which the computing device 12, user interfaces, and/or external resources may be operatively linked via some other communication media.

External resources 30 may include sources of information, external entities (e.g., a protected resource) participating with the computing device 12, and/or other resources. In some implementations, some or all of the functionality attributed herein to external resources may be provided by resources included in system 10.

The computing device 12 may include electronic storage 24, one or more processors 14, and/or other components. The computing device 12 may include communication lines, or ports to enable the exchange of information with a network and/or other computing platforms. Illustration of the computing device 12 in FIG. 1 is not intended to be limiting. The computing device 12 may include a plurality of hardware, software, and/or firmware components operating together to provide the functionality attributed herein to the computing device 12. For example, the computing device 12 may be implemented by a cloud of computing platforms operating together as the computing device 12.

Electronic storage 24 may comprise electronic storage media that electronically stores computer readable information. The electronic storage media of electronic storage 24 may include one or both of system storage that is provided integrally (i.e., substantially non-removable) with the computing device 12 and/or removable storage that is removably connectable to the computing device 12 via, for example, a port or a drive. A port may include a USB port, a firewire port, and/or other port. A drive may include a disk drive and/or other drive. Electronic storage 24 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 24 may include one or more virtual storage resources (e.g., cloud storage, a virtual private network, and/or other virtual storage resources). Electronic storage 24 may store software algorithms, information determined by processor 14, information received from the computing device 12, information received from user interfaces, and/or other information that enables the computing device 12 to function as described herein.

Processor(s) 14 is configured to provide information processing capabilities in the computing device 12. As such, processor 14 may include one or more of a digital processor, an analog processor, a digital circuit designed to process information, an analog circuit designed to process information, a state machine, and/or other mechanisms for electronically processing information. Although processor 14 is shown in FIG. 1 and FIG. 2 as a single entity, this is for illustrative purposes only. In some implementations, processor 14 may include one or more processing units. These processing units may be physically located within the same device, or processor 14 may represent processing functionality of a plurality of devices operating in coordination. The processor 14 may be configured to execute components 16, 18, 20, and 22. Processor 14 may be configured to execute components 16, 18, 20, and 22 by software; hardware; firmware; some combination of software, hardware, and/or firmware; and/or other mechanisms for configuring processing capabilities on processor 14.

It should be appreciated that although components 16, 18, 20, and 22 are illustrated in FIG. 1 as being co-located within a single processing unit, in implementations in which processor 14 includes multiple processing units, one or more of components 16, 18, 20, and 22 may be located remotely from the other components. The description of the functionality provided by the different components 16, 18, 20, and 22 described above is for illustrative purposes, and is not intended to be limiting, as any of components 16, 18, 20, and 22 may provide more or less functionality than is described. For example, one or more of components 16, 18, 20, and/or 22 may be eliminated, and some or all of its functionality may be provided by other ones of components 16, 18, 20, 22 and/or other components. As another example, processor 14 may be configured to execute one or more additional components that may perform some or all of the functionality attributed to one of components 16, 18, 20, and 22.

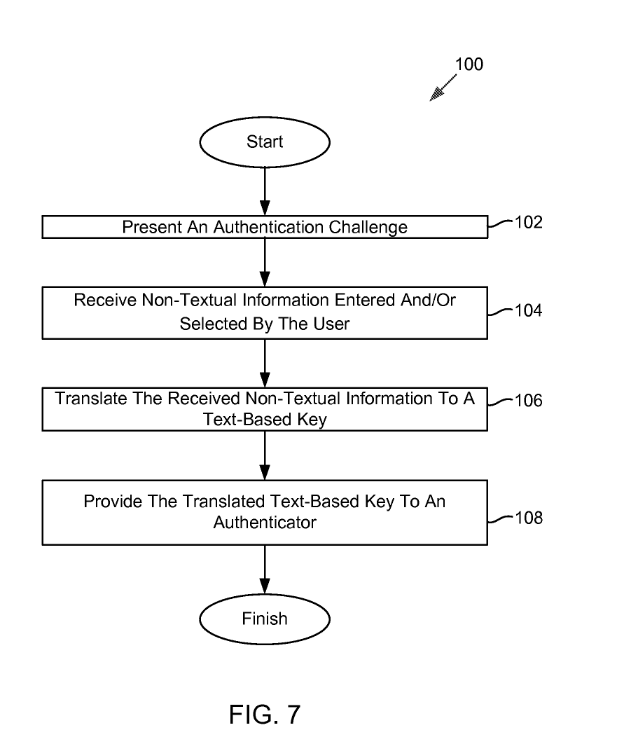

FIG. 7 illustrates a method 100 of challenge-response authentication. The operations of method 100 presented below are intended to be illustrative. In some implementations, method 200 may be accomplished with one or more additional operations not described, and/or without one or more of the operations discussed. Additionally, the order in which the operations of method 100 are illustrated in FIG. 7 and described below are not intended to be limiting.

In some implementations, method 100 may be implemented in one or more processing devices (e.g., a digital processor, an analog processor, a digital circuit designed to process information, an analog circuit designed to process information, a state machine, and/or other mechanisms for electronically processing information), and/or one or more other components. The one or more processing devices may include one or more devices executing some or all of the operations of method 100 in response to instructions stored electronically on an electronic storage medium. The one or more processing devices may include one or more devices configured through hardware, firmware, and/or software to be specifically designed for execution of one or more of the operations of method 100.

Referring now to method 100 in FIG. 1, at an operation 102, an authentication challenge may be presented to a user (for example, on a computing device). The authentication challenge may be presented in order to authenticate the user to a protected resource, for example a resource accessible through the computing device. In some implementations, operation 102 may be performed by a challenge component the same as or similar to challenge component 16 (shown in FIG. 1 and described herein).

At an operation 104, the non-textual information entered and/or selected by the user may be received as a response to the authentication challenge. In some implementations, operation 104 may be performed by a response component same or similar to response component 18 (shown in FIG. 1 and described herein).

At an operation 106, the received non-textual information may be translated to a text-based key. In some implementations, operation 106 may be performed by a translation component the same or similar to translation component 20 (shown in FIG. 1 and described herein).

At an operation 108, the translated text-based key may be provided to an authenticator to authenticate the user to a protected resource. In response to the authenticator authenticating the user based on the translated text-based key, the user may be provided access to the protected resource. In some implementations, operation 108 may be performed by an authentication component the same or similar to authentication component 22 (shown in FIG. 1 and described herein).

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A computing device for challenge-response authentication of a user, the computing device comprising:
one or more physical processors configured by computer-readable instructions to:
present an authentication challenge to the user of the computing device in order to authenticate the user to a protected resource accessible through the computing device;
receive non-textual information entered and/or selected by the user as a response to the authentication challenge;
translate the received non-textual information to a text-based key;
provide the translated text-based key to an authenticator to authenticate the user; and
in response to the authenticator authenticating the user based on the translated text-based key, providing access to the protected resource for the user.

2. The computing device of claim 1 wherein the one or more physical processors are configured by computer-readable instructions such that presenting the authentication challenge includes presenting visual information, wherein the receiving non-textual information comprises receiving user entry and/or selection of at least a portion of the presented visual information.

3. The computing device of claim 2 wherein the one or more physical processors are configured by computer-readable instructions such that visual information comprises one or more interface elements, wherein user entry and/or section comprises entry and/or selection of one or more of the interface elements, such that translating the received non-textual information to a text-based key comprises compiling the text-based key based on the user entry and/or selection of one or more of the interface elements.

4. The computing device of claim 3 wherein the one or more physical processors are configured by computer-readable instructions such that compiling the text-based key comprises compiling portions of the text-based key from text associated with the individual selections of the interface elements and/or sequences of selections of interface elements.

5. The computing device of claim 4 wherein the one or more physical processors are configured by computer-readable instructions such that the one or more interface elements comprise an array of interface elements, each interface element depicting one or more of a color and/or image.

6. The computing device of claim 4 wherein the one or more physical processors are configured by computer-readable instructions such that the one or more interface elements are associated with parts of a geometric shape.

7. The computing device of claim 1 wherein the one or more physical processors are configured by computer-readable instructions to access a database defining associations between elements of the authentication challenge and elements of the text-based string.

8. A method for challenge-response authentication of a user, the method being implemented with a computer system including one or more physical processors and storage media storing machine-readable instructions, the method comprising:
presenting an authentication challenge to the user in order to authenticate the user to a protected resource accessible through a computing device;
receiving non-textual information entered and/or selected by the user as a response to the authentication challenge;
translating the received non-textual information to a text-based key;
providing the translated text-based key to an authenticator to authenticate the user; and
in response to the authenticator authenticating the user based on the translated text-based key, providing access to the protected resource for the user.

9. The method of claim 8 wherein presenting the authentication challenge includes presenting visual information, wherein the receiving non-textual information comprises receiving user entry and/or selection of at least a portion of the presented visual information.

10. The method of claim 9 wherein visual information comprises one or more interface elements, wherein user entry and/or section comprises entry and/or selection of one or more of the interface elements, such that translating the received non-textual information to a text-based key comprises compiling the text-based key based on the user entry and/or selection of one or more of the interface elements.

11. The method of claim 10 wherein compiling the text-based key comprises compiling portions of the text-based key from text associated with the individual selections of the interface elements and/or sequences of selections of interface elements.

12. The method of claim 11 wherein the one or more interface elements comprise an array of interface elements, each interface element depicting one or more of a color and/or image.

13. The method of claim 11 wherein the one or more interface elements are associated with parts of a geometric shape.

14. The method of claim 8 additionally comprising accessing a database defining associations between elements of the authentication challenge and elements of the text-based string.
